(19) United States
(12) Patent Application Publication
(10) Pub. No.: US 2025/0045585 A1
(43) Pub. Date: Feb. 6, 2025

(54) METHOD FOR NEURAL NETWORK TRAINING WITH MULTIPLE SUPERVISORS

(71) Applicant: Dolby Laboratories Licensing Corporation, San Francisco, CA (US)

(72) Inventors: Jundai SUN, Beijing (CN); Lie LU, Dublin, CA (US); Zhiwei SHUANG, Beijing (CN); Yuanxing MA

(73) Assignee: Dolby Laboratories Licensing Corporation, San Francisco, CA (US)

(21) Appl. No.: 18/716,895

(22) PCT Filed: Dec. 8, 2022
(86) PCT No.: PCT/CN2022/137590

§ 371 Date: Jun. 5, 2024

Related U.S. Application Data
(60) Provisional application No. 63/298,314, filed on Jan. 11, 2022.

(30) Foreign Application Priority Data
Dec. 9, 2021 (WO) PCT/CN2021/136798

(51) Int. Cl. G06N 3/082

(52) U.S. Cl. CPC G06N 3/082

(57) ABSTRACT

The present disclosure relates to a method for designing a processor (20) and a computer implemented neural network. The method comprises obtaining input data and corresponding ground truth target data and providing the input data to a processor (20) for outputting a first prediction of target data given the input data. The method further comprises providing the latent variables output by a processor module (21: 1, 21: 2, . . . 21: n−1) to a supervisor module (22: 1, 22: 2, 22: 3, . . . 22: n−1) which outputs a second prediction of target data based on latent variables and determining a first and second loss measure by comparing the predictions of target data with the ground truth target data. The method further comprises training the processor (20) and the supervisor module (22: 1, 22: 2, 22: 3, . . . 22: n−1) based on the first and second loss measure and adjusting the processor by at least one of removing, replacing and adding a processor module.

### TECHNICAL FIELD OF THE INVENTION

The present invention relates to a method for designing a neural network using at least one supervisor. The present disclosure also relates to a computer-implemented neural network, and more specifically a nested block neural network.

### BACKGROUND OF THE INVENTION

Neural networks have recently shown to be well suited to process and analyze many types of information. For instance, neural networks have shown suitable for predicting masks to separate individual audio sources in an audio signal comprising multiple, mixed, audio sources. For example, this has resulted in completely new, and very effective, types of noise suppression and speech enhancement. Likewise, neural networks have shown promising results for enhancement, compression, and analysis of image and video data.

The performance of a neural network is determined in part by its architecture (e.g. the number and types of neural network layers, size of convolutional kernels etc.) and in part by the amount and type of training data used.

The process of determining a suitable architecture for a neural network is commonly a trial-and-error process wherein researchers simply evaluate the final prediction performance of many different known neural networks architectures to determine which one performs best for the current application. The initial selection of architectures to evaluate is narrowed by e.g. device constraints or the type of data to be processed. For example, if the device which is intended to actuate the neural network model has limited capabilities in terms of computing performance, neural network architectures with a smaller number of parameters becomes the primary focus.

Additionally, there exists some rule-of-thumb guidelines for determining a suitable neural network architecture. For example, when processing audio signals it has been shown generally that longer receptive fields lead to more accurate, but also more complicated, neural network models and that fewer learnable parameters are suitable when processing less data.

Regarding training it is generally known that the more training data used during training the more accurate and capable the neural network becomes. However, it is important to ensure that the neural network does not become overfitted by the training data, rendering it incapable of operating on new data. To this end, it is common to distort or otherwise augment the training data to mitigate the risk of the neural network learning to identify abstract patterns in the training data rather than specific details.

### GENERAL DISCLOSURE OF THE INVENTION

A drawback with the current methods for designing and training neural networks is that researchers are not able to easily distinguish which parts of a neural network architecture that are functioning well, and which parts are functioning less well. This makes the task of improving a known neural network architecture difficult which often leads to researchers having to resort to a trial-and-error process.

Additionally, researchers are also trying to apply neural networks on a vast variety of different computing systems including servers, personal computers, mobiles, smartwatches, and even earbuds or earphones. However the process of designing neural networks to be runnable on devices with different calculating power is challenging. Usually, researchers will try to develop a candidate model which is runnable on a high performance server and then try to optimize the model and reduce the complexity of the model to make it simple and suitable for implementation on more constrained devices. As each new architecture requires a new round of training, the process is generally time consuming and labor intensive. For instance, researchers must train the model again and again to find a balance between accuracy and model complexity.

To this end, there is a need for an improved method for designing a neural network and an improved neural network architecture.

It is a purpose of the present disclosure to provide such an improved method for designing neural networks and an improved neural network architecture which overcomes at least some of the shortcomings of the prior solutions.

A first aspect of the present invention relates to a method for designing a neural network wherein the method comprises obtaining input data and corresponding ground truth target data and providing the input data to a neural network processor comprising a plurality of trainable nodes for outputting a first prediction of target data given the input data. The neural network processor comprises a consecutive series of initial processing modules, each initial processing module comprising a plurality of trainable nodes for outputting latent variables that are used as input data to a subsequent initial processing module in the series, and a final processing module comprising a plurality of trainable nodes for outputting the first prediction of target data given latent variables from a final initial processing module. The method further comprises providing the latent variables output by at least one initial processor module to a supervisor module, the supervisor module comprising a plurality of trainable nodes for outputting a second prediction of target data based on latent variables and determining a first loss measure and a second loss measure by comparing the first prediction of target data with the ground truth target data and comparing the second prediction of the target data with the ground truth target data, respectively. The method further comprises training the trainable nodes of the neural network processor and the supervisor module based on the first loss measure and second loss measure and adjusting the neural network processor based on the first loss measure and the second loss measure, wherein adjusting the neural network comprises at least one of removing an initial processor module, replacing a processor module and adding a processor module.

The method is at least partially based on the understanding that with this method the efficiency of the neural network processor, as well as the efficiency of the training, is enhanced. Additionally, by using at least one supervisor for determining a second prediction of the target, it is possible to monitor the neural network processor to establish which initial processor modules of the neural network processor contribute more and which initial processor modules contribute less. This enables less useful initial processor modules to be removed, or replaced with other types of processor modules, meaning that the neural network system is not only trained in the traditional manner of adjusting learnable parameters but also adjusted with regards to its architecture as the number and/or type of processor modules changes.

Furthermore, since the at least one supervisor module outputs a prediction of the target data, each supervisor module may be used together with the preceding to initial processor modules to form a complete neural network called a neural network section. In other words, each supervisor module and the preceding initial processor modules forms a complete neural network in the form of a neural network section. Similarly, all initial processor modules together with the final processor module also forms a neural network section. Thus, the method allows a plurality of neural network sections to be trained simultaneously, for the same task, wherein each neural network section is of a different complexity (having a different number of nodes and/or learnable parameters).

A second aspect of the present invention relates to a computer-implemented neural network comprising a nested block, the nested block comprising at least a first floor and a second floor, wherein the first floor comprises a number n−1 of consecutive neural network sub-modules operating on high resolution input data and the second floor comprises a number n−2 of consecutive neural network sub-modules operating on low resolution input data. Wherein a first sub-module of the first floor is trained to predict high resolution latent variables based on high resolution input data, wherein a first sub-module of the second floor is trained to predict low resolution latent variables based on low resolution input data and high resolution latent variables from the first sub-module of the first floor, and wherein a second sub-module of the first floor is configured to predict high resolution second latent variables based on the high resolution latent variables and low resolution latent variables.

Accordingly, the second aspect of the invention relates to an improved neural network architecture which is particularly suitable for use in the method for designing a neural network processor according to the first aspect.

In some implementations, the nested block is combined with a multi-scale input block and an aggregation neural network block to form a multi-block neural network architecture. This multi-block architecture is sometimes referred to as a block joint network (BJN or BJNet). In some implementations, the nested block comprises two floors (referred to as BJNet2). In some implementations, the nested block further comprises a third floor with n−3 sub-modules modules (referred to as BJNet3), and, optionally a fourth floor with n−4 sub-modules (referred to as BJNet4).

### BRIEF DESCRIPTION OF THE DRAWINGS

Aspects of the present invention will be described in more detail with reference to the appended drawings, showing currently preferred embodiments.

FIG. 1a depicts a block-chart of a neural network system according to some implementations.

FIG. 1b is a block-chart showing a feature extractor according to some implementations.

FIG. 1c is a block-chart showing a processor according to some implementations.

FIG. 2 is block-chart describing a method for training a neural network processor according to some implementations.

FIG. 3 is block-chart describing a method for training a neural network processor comprising one or more supervisor modules according to some implementations.

FIG. 4a is a block-chart showing how latent variables are passed from one processor module to a next processor module according to some implementations.

FIG. 4b is a block-chart showing how latent variables are passed from one processor module to a next processor module alongside downsampled input data according to some implementations.

FIG. 5a depicts schematically a block joint network (BJNet) with a processor, a multi-scale input block and an aggregation neural network block according to some implementations.

FIG. 5b depicts schematically the processor modules of a block joint network (BJNet) according to some implementations.

FIG. 5c depicts schematically a block joint network (BJNet) with supervisor modules in an alternative arrangement according to some implementations.

FIG. 6 is a flowchart describing a method for designing a neural network processor according to some implementations.

FIG. 7a is a block-chart describing a first type of neural network sub-module according to some implementations.

FIG. 7b is a block-chart describing a shuffle convolutional layer of the first type of neural network sub-module.

FIG. 8 is a block-chart describing a second type of neural network sub-module according to some implementations.

FIG. 9 is a block-chart describing a third type of neural network sub-module according to some implementations.

### DETAILED DESCRIPTION OF CURRENTLY PREFERRED EMBODIMENTS

Systems and methods disclosed in the present application may be implemented as software, firmware, hardware or a combination thereof. In a hardware implementation, the division of tasks does not necessarily correspond to the division into physical units; to the contrary, one physical component may have multiple functionalities, and one task may be carried out by several physical components in cooperation. The computer hardware may for example be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions (sequential or otherwise) that specify actions to be taken by that computer hardware. Further, the present disclosure shall relate to any collection of computer hardware that individually or jointly execute instructions to perform any one or more of the concepts discussed herein.

Certain or all components may be implemented by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system (i.e. a computer hardware) that includes one or more processors. Each processor may include one or more of a CPU, a graphics processing unit, and a programmable DSP unit. The processing system further may include a memory subsystem including a hard drive, SSD, RAM and/or ROM. A bus subsystem may be included for communicating between the components. The software may reside in the memory subsystem and/or within the processor during execution thereof by the computer system.

The one or more processors may operate as a standalone device or may be connected, e.g., networked to other processor(s). Such a network may be built on various different network protocols, and may be the Internet, a Wide Area Network (WAN), a Local Area Network (LAN), or any combination thereof.

The software may be distributed on computer readable media, which may comprise computer storage media (or non-transitory media) and communication media (or transitory media). As is well known to a person skilled in the art, the term computer storage media includes both volatile and non-volatile, removable and non-removable media implemented in any method or technology for storage of information such as computer readable instructions, data structures, program modules or other data. Computer storage media includes, but is not limited to, physical (non-transitory) storage media in various forms, such as EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. Further, it is well known to the skilled person that communication media (transitory) typically embodies computer readable instructions, data structures, program modules or other data in a modulated data signal such as a carrier wave or other transport mechanism and includes any information delivery media.

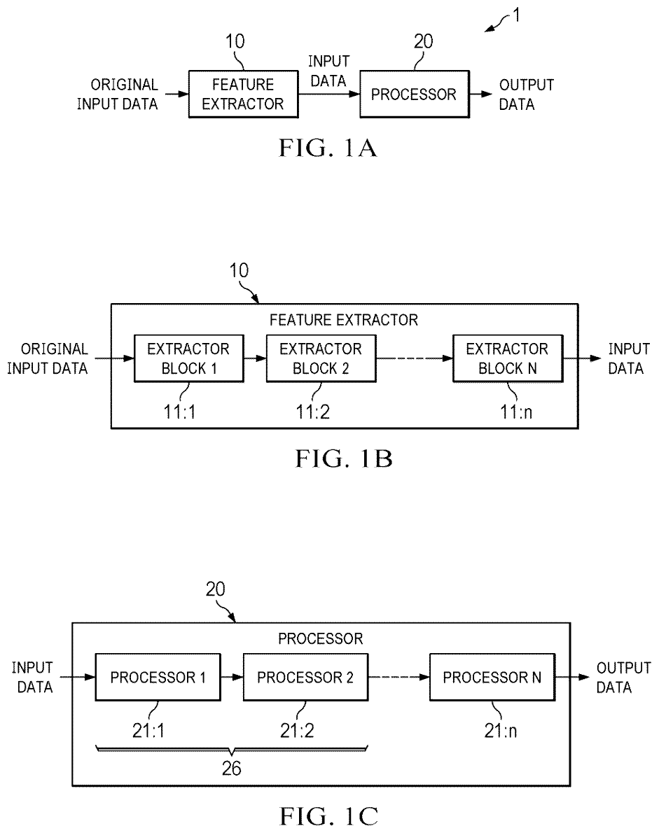

FIG. 1a is block-chart describing schematically a neural network system 1. The neural network system 1 obtains original input data, processes the original input data, and outputs output data. The neural network system 1 comprises a neural network feature extraction system 10, also referred to as a feature extractor 10, and a subsequent neural network processor 20.

The feature extractor 10 comprises one or more neural network layers trained to extract a feature representation of the original input data. The feature representation may be a set of latent variables of a latent space, i.e. a representation which has been learned by the feature extractor 10 during training. Prior to the training, only the hyperparameters (e.g. the number of channels) of the latent space may be specified. In most cases, the latent space will comprise more channels compared to the original input data. That is, in general the dimension of the latent variables will be higher, or at least different, from the dimensions of the original input data. As an example, the original input data may be samples of an audio signal in time domain which comprises one single channel whereas the latent variables comprise two or more channels, such as more than eight channels or even more than sixteen channels. Each channel may be referred to as a “feature” or a “feature channel”.

The features from the feature extractor 10 are provided to a processor 20 as input data wherein the processor 20 comprises one or more neural network layers with trainable neural network nodes to process the extracted features so as to predict the output data (also called the target data), which is a learned enhancement of the original input data. Contrary to the feature extractor 10, at least two or most of the neural network layers of the processor 20 may be configured to maintain the dimensionality of the feature domain latent representation output by the feature extractor 10. In some implementations, the neural network layers of the processor 20 will stepwise modify the dimensions of the latent feature representation and approach the dimensions of the original input data so as to e.g. output an enhanced mono audio signal in the form of single channel data being an enhancement of the input mono audio signal of the single channel input data.

That is, the purpose of the feature extractor 10 is to extract features and convert them to a different (commonly higher) dimension that are easier for the processor 20 to process. The processor 20 will then converge the features to a target output and finally get a prediction of the enhanced target data.

FIG. 1b shows further details of the feature extractor 10. As seen, the feature extractor 10 comprises a plurality of feature extractor blocks 11:1, 11:2, . . . 11:n, which also are referred to as extractor modules 11:1, 11:2, . . . 11:n. Each extractor module 11:1, 11:2, . . . 11:n comprises at least one neural network layer with a plurality of trainable nodes. The type of neural network layer(s) used in each module may be one or more of a convolutional layer and a recurrent layer. In some implementations, there are more than two layers in an extractor module so as to form a deep neural network (DNN). The feature extractor 10 obtains original input data, processes the original input data and outputs latent variables used as input data by the subsequent processor.

It is understood that the dimensions of the data passed from one extractor module 11:1 to a subsequent extractor module 11:2 may be different from the dimensions of the data passed between two other subsequent extractor modules in the feature extractor 10.

In many cases the data referred to in this disclosure is of the dimension N*W*H*C where N represents the batch size, W the width, H the height and C the number of channels. For example, when employing two-dimensional convolutional neural network layers, the size W*H is the size of each feature map and the channel number C is the number of feature maps. Accordingly, the dimensions N*W*H*C may change from one neural network layer to another, depending e.g. on the number of filters used. For instance, the dimensions may be increased, meaning that at least one of W, H and C increases, or decreased, meaning that at least one of W, H and C decreases. Commonly, the term downsampling or upsampling is used to denote a decrease or increase in at least one of the width W dimension and/or the height H dimension. As will be described in the below, there are multiple ways in which the dimensions may be increased or decreased. In some implementations, the number of channels C is changed in an upsampling or downsampling process as well. Commonly, the number of channels C is changed to keep a similar amount of data when the height H dimension and width W dimension is changed. For instance, when H and/or W is downsampled the number of channels C may be increased to keep a similar amount of information.

FIG. 1c shows further details of the processor 20. As seen, the processor 20 comprises a plurality of processor blocks 21:1, 21:2, . . . 21:n, which also are referred to as processor modules 21:1, 21:2, . . . 21:n. Each processor module 21:1, 21:2, . . . 21:n comprises at least one neural network layer comprising a plurality of trainable nodes and the output of one processor module 21:1 is used as input to a subsequent processor module 21:2. The type of neural network layer(s) used in each processor module 21:1, 21:2, . . . 21:n may be one or more a convolutional layer and a recurrent layer. In some implementations, one or more processor modules 21:1, 21:2, . . . 21:n comprises a plurality of layers forming a deep neural network (DNN). Just as for the feature extractor, the dimension of the data fed between one processor module 21:1 and a next processor module 21:2 may have a dimension of N*W*H*C.

The processor 20 obtains input data (latent variables) from the feature extractor, processes the input data and outputs a first prediction of the target data as output data.

The processor modules 21:1, 21:2, . . . 21:n of the processor 20 are divided into a group 26 of initial processor modules 21:1, 21:2, . . . 21:n−1 and a final processor module 21:n. The initial processor modules 21:1, 21:2, . . . 21:n−1 processes the data whereas the final processor module 21:n takes the output of the final initial processor module 21:n−1 and outputs a final prediction of the target data.

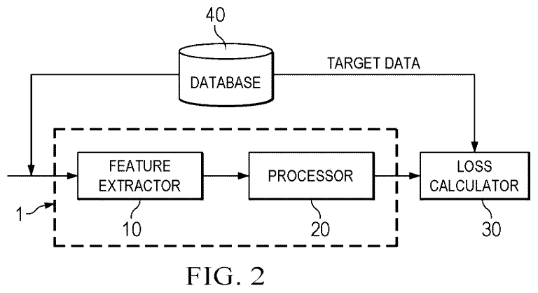

FIG. 2 depicts a setup for training the neural network system 1. A database 40 comprises training data, wherein the training data comprises a set of training original input data and associated ground truth target data. The training original input data may be distorted, downsampled, or compressed wherein the corresponding ground truth target data is an undistorted, un-compressed or otherwise enhanced version of the training original input data. That is, the training original input data and ground truth target data are examples of the processing (e.g. undistort, un-compress or enhance) the neural network system 1 should learn to perform.

There are many examples of what this processing may entail and a few examples for audio signal processing is noise reduction, source separation (e.g. separating speech or music from an audio signal comprising a mix of audio sources), speech-to-text processing, text-to-speech processing, packet- or frame-loss compensation, reconstructing omitted spectral information, audio encoding and decoding and voice activity detection. For image and video processing a few examples are image or video generation, image or video encoding and decoding, image or video enhancement, image or video colorization and object detection (e.g. detecting whether a person or animal is represented in an image or video segment).

For instance, if the neural network system 1 is to be trained to perform noise reduction, the original input data will be examples (e.g. short segments) of audio with noise whereas the ground truth target data will be corresponding examples without noise. For instance, the ground truth target data may be obtained by performing other types of noise reduction on the noisy training original input data or, alternatively, noise is added to otherwise clear ground truth training data to form the training original input data.

During the training process, the trainable nodes of neural network system 1 will be adjusted gradually so as to learn how noise from audio signals is to be removed. After training, the neural network system 1 may be applied to new original input data which was not included in the training database 40, this is often referred to as using the neural network system 1 in inferencing mode.

More specifically, the (e.g. distorted) training original input data is provided to the feature extractor 10 which outputs latent feature variables of the training original input data which is used as input data to the processor 20. The processor 20 operates on the latent feature variables and converges the dimensions towards the dimension of the target output data and the ground truth target data. The processor 20 will output a prediction of the target data which is provided to a loss calculator 30.

The loss calculator 30 compares the predicted target data with the ground truth target data and determines at least one measure of the difference between the predicted target data and the ground truth target data. Based on the at least one measure of the difference a loss is determined and based on this loss, the internal parameters of the neural network architecture are adjusted to reduce the loss. This process is repeated many times until a neural network system 1 which results in a sufficiently small loss for the training data is acquired.

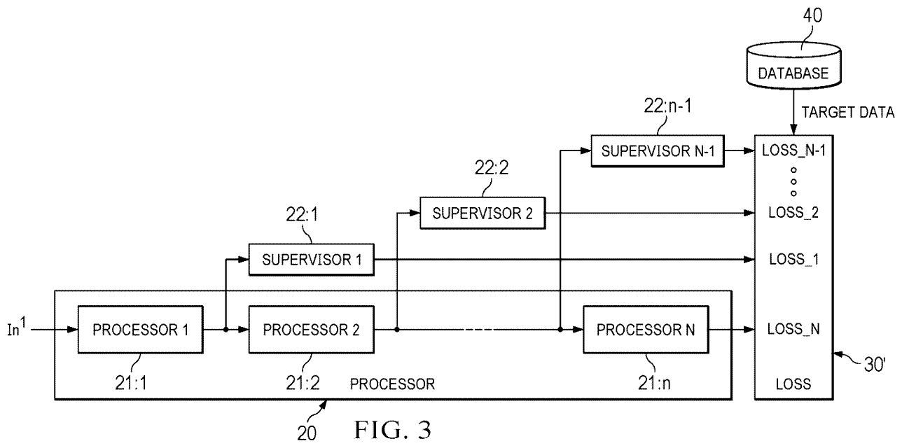

With reference to FIG. 3 a training setup according to some implementations is shown. As seen, this training is performed for the processor 20 wherein the processor 20 receives latent (feature) variables input data In¹ from a preceding feature extractor (not shown). For example, the feature extractor has already been trained and is provided separately. In some implementations, the feature extractor is trained together with the processor, in a manner analogous to the training of the processor as is descried herein.

The input data In¹ provided to the processor 20 is processed sequentially with the initial processor modules 21:1, 21:2, . . . , 21:n−1 whereby the final processor module 21:n outputs a prediction of the target data which is provided to a loss calculator 30′. The loss calculator 30′ determines a loss LossN based on the difference between the predicted target data and the ground truth target obtained from a database 40.

At least one supervisor module 22:1, 22:2, . . . , 22:n−1 is also shown in FIG. 3. In some implementations, there are at least two different supervisor modules 22:1, 22:2, . . . , 22:n−1. In some implementations, each initial processor module 21:1, 21:2, . . . 21:n−1 is associated with a subsequent supervisor module 22:1, 22:2, . . . , 22:n−1. Each supervisor module 22:1, 22:2, . . . , 22:n−1 comprises at least one neural network layer with trainable nodes that predict the target data based on the latent variables output by the preceding initial processor module 21:1, 21:2, . . . , 21:n−1.

As seen, each supervisor module 22:1, 22:2, . . . , 22:n−1 is trained together with the processor modules 21:1, 21:2, . . . , 21:n of the processor 20. For example, supervisor 22:2 takes the latent variables output by processor module 21:2 and predicts the target data. Accordingly, for each supervisor module 22:1, 22:2, . . . , 22:n−1 an associated prediction of the target data is obtained. Each supervisor module 22:1, 22:2, . . . , 22:n−1 thereby generates an additional prediction of the target data in addition to the prediction outputted by the final processor module 22:n.

The prediction of each supervisor module 22:1, 22:2, . . . , 22:n−1 is provided to a loss calculator 30′ which determines an individual loss, Loss1, Loss2, . . . . LossN for each supervisor module 22:1, 22:2, . . . , 22:n−1 and the final processor module 21:n. The losses are used to train the processor modules 21:1, 21:2, . . . , 21:n and the supervisor modules 22:1, 22:2, . . . , 22:n−1 by updating the internal weights of each trainable node to decrease the losses. When training a processor module 21:1, 21:2, . . . , 21:n or supervisor module 22:1, 22:2, 22:n−1 more than one loss may be used. For example, when updating the internal weights of a specific processor module 21:i all losses associated with subsequent supervisor modules 22:i . . . 22:n−1 and the final processor module 21:n may be considered.

In general, there will be a mismatch in dimension between the latent variables output by any one of the processor modules 21:1, 21:2, . . . 21:n−1 and the target data. To this end, each supervisor module 22:1, 22:2, . . . , 22:n−1 comprises one or more neural network layers for converting the latent variables to the same dimension of the target data. For example, each supervisor may comprise a 1*1 convolutional layer with the same channel number as the target data dimension for performing this conversion. In some implementations, the supervisor modules 22:1, 22:2, . . . , 22:n−1 may also use upsampling or downsampling to make the width W and height H match between the latent variables and the 1*1 convolutional layer.

As each supervisor module 22:1, 22:2, . . . , 22:n−1 adds to the total complexity of the processor 20 during training it is beneficial if each supervisor module 22:1, 22:2, . . . , 22:n−1 is kept simple. For instance, it is envisaged that the supervisor comprises only a 1*1 convolutional layer with one or more upsampling or downsampling modules to make the prediction of the target data. Alternatively, each supervisor module 22:1, 22:2, . . . , 22:n−1 may have an architecture resembling or being equal to the architecture of the final processor module 21:n.

The processor modules 21:1, 21:2, . . . , 21:n are expected to step-by-step process the data to approach the final prediction of the target data. In general, it is expected that more neural network layers (i.e. more processing modules) will generate more accurate results at the cost of added complexity. Accordingly, the latent variables of later processor modules 21:1, 21:2, . . . , 21:n may be expected to be associated with a lower loss compared to the latent variables output by processor modules 21:1, 21:2, . . . , 21:n occurring earlier in the series. However, each processor module 21:1, 21:2, . . . , 21:n will not make the same level of contribution towards reducing the loss, meaning that when analyzing the losses Loss1, Loss2, . . . . LossN determined based on the predicted target data of each supervisor module 22:1, 22:2, . . . , 22:n−1 and the final processor module 21:n the loss will often be higher for earlier supervisor modules and lower for later supervisor modules, with the loss of the final processor module 21:n being the lowest.

These losses may indicate which processor modules 21:1, 21:2, . . . , 21-n that make the greatest contribution for the processing. For example, if the losses as determined by a supervisor module just before, and a supervisor module just after, a specific processor module(s) are very similar, it may be concluded that this specific processor module(s) does not make a great contribution to the processing. On the other hand, if the loss as determined by supervisors just before and just after one or more specific processor modules drops from a higher level to a lower level, it may be concluded that this specific processor module(s) makes a greater contribution to the processing.

In this way, it may be determined which processor module(s) that are most important for the processing and which processor module(s) that are less important. For instance, the less important processor module(s) could be removed or replaced with other module types before continuing with the training.

To this end, it is understood that the processor 20 architecture is dynamically adjusted as the training continues, with the learnable nodes of processor modules being updated and/or wherein at least one architectural adjustment is made based on the losses Loss1, Loss2, LossN, the architectural adjustment being at least one of removing a processor module, replacing a processor module with a different processor module or adding a processor module.

Additionally, the processor 20 can be divided into one or more neural network sections, wherein each neural network sections comprises a supervisor 22:1, 22:2, . . . 22:n−1 and all preceding initial modules 21:1, 21:2, . . . 21:n−1 or all initial modules 21:1, 21:2, . . . 21:n−1 and the final module 21:n. Accordingly, the same training process ensures that there at all times are multiple neural network sections of varying degree of complexity present. For instance, a less complex neural network section, comprising only a true subset of the initial processor modules and the supervisor module operating after the last initial module in the true subset, may be used on more constrained devices at the cost of a slightly higher loss. By comparison a more complex neural network section comprising the initial modules of the less complex section, and additional initial modules together with a later supervisor module or the final processor module, may be used on more capable devices to obtain a prediction with lower loss.

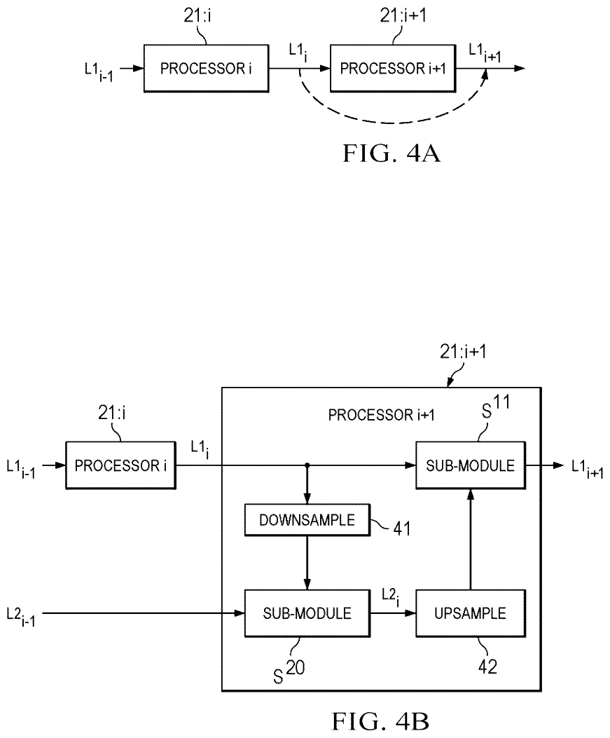

FIG. 4a depicts in detail how data is passed from one initial processor module 21: j to a subsequent initial processor module 21:i+1. As seen, the initial processor module 21:i receives latent variables L1ᵢ₋₁ of a preceding initial processor module 21:i−1 (not shown), processes the latent variables L1ᵢ₋₁ and outputs new latent variables L1ᵢ which are provided to the next initial processor module 21:i+1 in the series. The next initial processor module 21:i+1 processes the latent variables L1ᵢ to obtain new latent variables L1ᵢ₊₁ which are provided to a next initial processor module or the final processor module. The same process is repeated for all initial processor modules 21:i, 21:i+1 in the processor.

The latent variables L1ᵢ₋₁ may e.g. be the input data provided to the processor as such, meaning that the initial modules 21:1, 21:i+1 of FIG. 4a are the first and second initial processing modules 21:1, 21:2 of the processor 20 shown in FIG. 3.

As also shown in FIG. 4a it is envisaged that the initial processor modules 21:i, 21:i+1 are arranged as dense modules with skip connections, meaning that the latent variables L1ᵢ output by one initial processor module 21:i is provided as input to each subsequent initial processor module.

With reference to FIG. 4b, the initial processor module 21:i and subsequent initial processor module 21:i+1 are shown operating on multi-scale latent variables L1ᵢ₋₁ and L2ᵢ₋₁ according to some implementations. The initial processor module 21:i+1 is configured to obtain the latent variables L1ᵢ from the preceding initial processor module 21:i and also latent variables of a lower resolution L2ᵢ₋₁ from e.g. a lower resolution, preceding, processor module or a multi-scale input block as is described in further detail in the below. Accordingly, the initial processor module 21:i+1 combines two sets of latent variables L1ᵢ, L2ᵢ₋₁ of different resolution and bases the prediction of the latent variables L1ᵢ₊₁ on both sets of input latent variables L1ᵢ, L2ᵢ₋₁.

To this end, the initial processor module 21:i+1 comprises a first sub-module S¹¹ and a second sub-module S²⁰. Each sub-module S¹¹, S²⁰ comprises at least one neural network layer with learnable nodes.

The second sub-module S²⁰ is trained to predict an intermediate set of latent L2ᵢ variables based on the lower resolution latent variables L2ᵢ₋₁.

The first sub-module S¹¹ is trained to predict high resolution latent variables L1ᵢ₊₁ based on the low resolution intermediate set of latent variables L2; and the high resolution latent variables L1ᵢ.

The higher resolution latent variables may have a larger dimension in at least one of the width W, height H, or number of channels C compared to the lower resolution latent variables. In some cases, the change in dimension is in at least one of the width W and height H wherein the number of channels C is maintained.

In some implementations, each sub-module S¹¹, S²⁰ is configured to maintain the dimension of the latent variables during the processing. That is, each respective sub-module S¹¹, S²⁰ outputs latent variables with the same height H, width W, and number of channels C as the latent variables input to the respective sub-module S¹¹, S²⁰. Thus, it is envisaged that an upsampling block 222 is used to upsample the intermediate latent variables L2; prior to providing them to the first sub-module S¹¹ such that the two sets of input data provided to the first sub-module S¹¹ have matching dimensions.

In some implementations, the second sub-module S²⁰ is configured to predict the intermediate latent variables L2ᵢ further based on the high resolution latent variables L1ᵢ. To this end, the high resolution latent variables L1ᵢ are provided to the second sub-module S²⁰ alongside the low resolution latent variables L2ᵢ₋₁ whereby the second sub-module S²⁰ is trained to predict the intermediate latent variables L2ᵢ based on these two sets of input latent variables. To make dimensions match, there may be provided a downsampling block 221 which takes the high resolution latent variables L1ᵢ and downsamples to the lower resolution used by the second sub-module S²⁰.

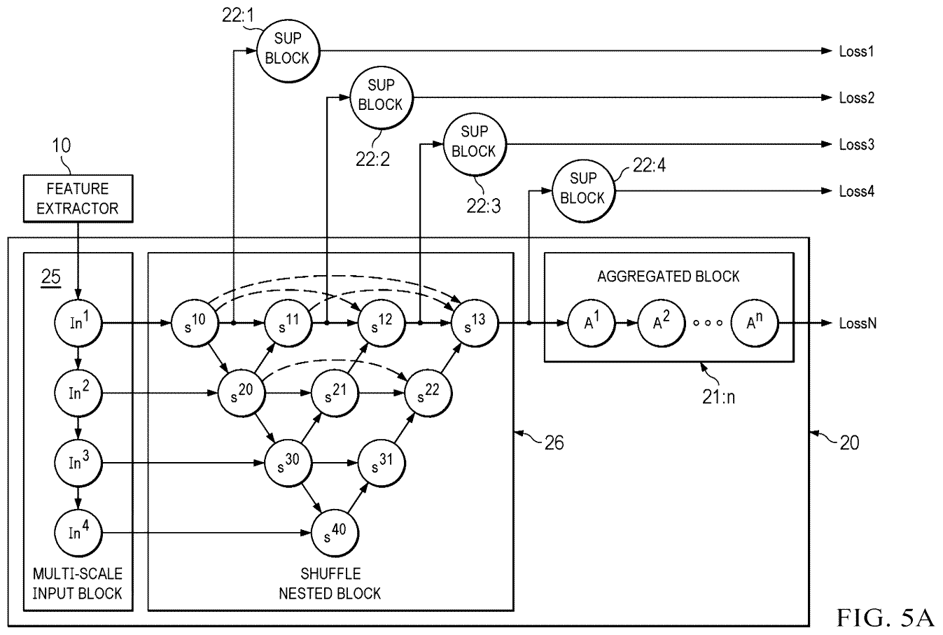

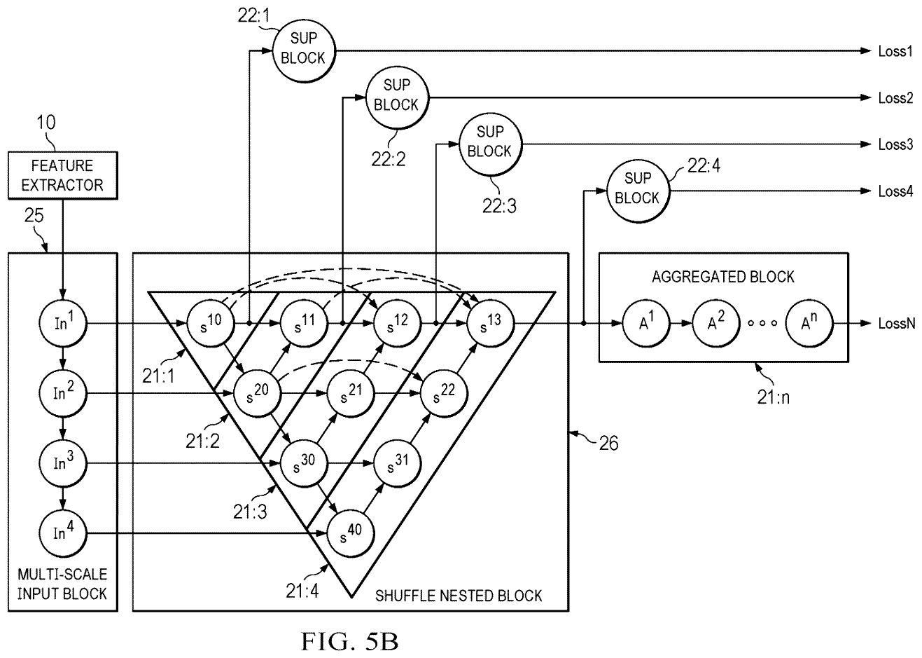

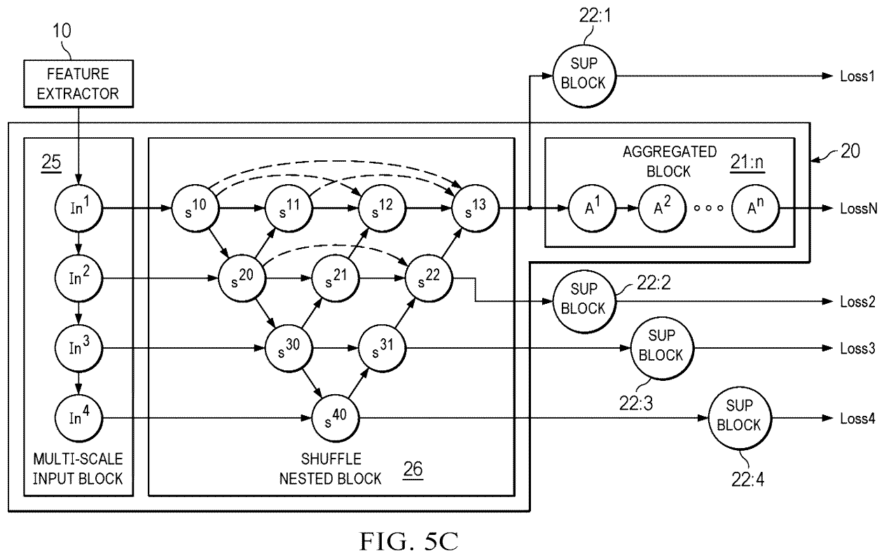

The initial processor module 21:i+1 of FIG. 4b has two sub-modules S¹¹, S²⁰ and operates on two resolutions of latent variables. It is understood that the initial processing module 21:i+1 may analogously be configured to operate on more than two resolutions as well, such as three or four resolutions. This will now be explained with reference to FIG. 5a which shows the initial processor modules realized a nested block.

In FIG. 5a, the feature extractor 10 provides a set of latent variables as input data In¹ to the processor 20. The processor 20 further comprises a multi-scale input block 25 for downsampling input data In¹ to multiple downsampled resolutions In², In³ and In⁴. More specifically, the multi-scale input block 25 downsamples the input data In¹ to first downsampled resolution, forming first downsampled input data In². The multi-scale input block 25 further downsamples the first downsampled input data In² to a second downsampled resolution, forming second downsampled input data In³ and downsamples the second downsampled input data In³ to a third downsampled resolution, forming third downsampled input data In⁴.

As described in the above the downsampling may be in any dimension of the width W and height H. In some implementations, the number of channels is maintained whereby only the width W and/or height H dimension is reduced by the downsampling. In some implementations, the number of channels C is increased (e.g. by using additional convolutional filters) when W and/or H is downsampled to keep a similar amount of information.

The downsampling of the multi-scale input block 25 may be performed with convolutional neural layers using a stride of two or more. Alternatively, downsampling may be achieved using dense layers wherein there is a smaller number of nodes than the dimension of the input data.

For convolutional neural network layers, the i-th resolution Inⁱ of the multi-scale input block 25 can be obtained as

$${In}^{i} = Conv2D ( channel , kernel , stride , dilation ) ( {In}^{i - 1} ) , i \geq 1 \qquad Eq . 1$$

wherein Conv2D (channel, kernel, stride, dilation) (x) represents a two-dimensional convolutional layer operating on data x. The parameters channel, kernel, stride, dilation represent the number of channels, the kernel (filter) size, the stride step and the dilation factor. To perform downsampling the stride factor is set to stride>1 such that the dimension is reduced. The remaining parameters are set depending on the particular use case. For example, different kernel sizes or dilation factors could be used. Additionally, the downsampling may be performed in multiple steps, with multiple convolutional layers.

For dense layer based downsampling the i-th resolution In is obtained as

$$I {n}^{i} = Dense ( {node}^{i} ) ( {In}^{i - 1} ) , i \geq 1 \qquad Eq . 2$$

wherein nodeⁱ is the number of nodes of the dense layer, and nodeⁱ<nodeⁱ⁻¹. The notation Dense (a) (x) denotes a dense neural network operating on data x, wherein the parameter a indicates the number of nodes in the output layer of the dense neural network.

Another option for performing downsampling is using one or more pooling layers which implement average pooling or max pooling. There are many pooling methods which are possible to use and in the below two examples are presented, L_{P}-pooling and mixed-pooling.

For L_{P}-pooling, the (f+1)-th resolution of the input data In^{(f+1)} is obtained as

$${In}_{i , j}^{f + 1} = {\frac{1}{{R}_{i , j}} [ {\sum }_{m , n ∈ {R}_{i , j}} {( {In}_{m , n}^{f} )}^{p} ]}^{\frac{1}{p}} \qquad Eq . 3$$

In_{i,j}^{f+1} is the input to the processor (i.e. the output of the pooling operator) at the (f+1)-th floor at location I, j. The term In_{m,n}^{f} is the data provided as input to the multi-scale input block 25, i.e. the output data of the feature extractor 10. More precisely, In_{m,n}^{f} denotes a value at location m, n within the pooling region R_{i,j} of the f-th floor. The pooling region R_{i,j} is accompanied with a window size k wherein R_{i,j} is a rectangle in the width W and height H dimension centered at i, j extending k elements on either side of the i, j element. In other words, the pooling region for each i, j may be given by elements i−k, i−k+1, . . . i, . . . , i+k−1, i+k and j−k, j−k+1, . . . j, . . . j+k−1, j+k along the width and height direction respectively. That is, the pooling region R_{i,j} comprises at least two elements (e.g. four elements or nine elements) extending along the width W and/or height H dimension. Alternatively, the window size k is set individually and may be different along the width W and height H dimension. Additionally or alternatively, the pooling region R_{i,j} is asymmetrical for one of the width W and height H direction whereby the window is asymmetrical around the i, j element. As an example, the window size along one dimension is set as j−k, j−k+1, . . . j meaning that the pooling region R_{i,j} extends only in one side of element j in the j-dimension. An asymmetrical window pooling may e.g. be used when one of the width W and height H dimension is a temporal dimension wherein an asymmetric window may be used so as to only process data of a current time segment or previous time segments which enables the latency to be reduced.

The reciprocal 1/R_{i,j} is evaluated as one divided with the number of elements in the pooling region R_{i,j}. For example, if R_{i,j} comprises X elements, 1/R_{i,j}=1/X.

For different values of p the L_{P}-pooling will behave differently. For example, if p=1 the Lₚ-pooling corresponds to average pooling and when p approaches ∞ the Lₚ-pooling approaches max pooling.

For mixed pooling, the (f+1)-th resolution of the input data In^{(f+1)} is obtained as

$${In}_{i , j}^{f + 1} = λ {max}_{( m , n ∈ {R}_{i , j} )} {In}_{m , n}^{f} + ( 1 - λ ) \frac{1}{{R}_{i , j}} {\sum }_{m , n ∈ {R}_{i , j}} {In}_{m , n}^{f} \qquad Eq . 4$$

where λ is a random binary value (being either zero or one) chosen for each value of i, j. If λ is zero equation 4 indicates average pooling and if λ is one equation 4 indicates max pooling. During training (i.e. during a forward-propagation process) the resulting value of λ is recorded so as to be used when the internal weights of the learnable nodes are updated (i.e. during a back-propagation process). For each training iteration, the recorded values of λ are kept and used repeatedly when updating the internal weights of the learnable nodes.

The different resolutions of the input data In¹, In², In³, In⁴ are provided to the initial processor modules 26 which in the embodiment of FIG. 5a form a nested block comprising a plurality of sub-modules S¹⁰, S¹¹, S¹², S¹³, S²⁰, S²¹, S²², S³⁰, S³¹, S⁴⁰. The sub-modules are arranged in different horizontal levels called floors, wherein each floor is associated with a resolution of the data. Sub-modules S¹⁰, S¹¹, S¹², S¹³ belong to the first floor operating on the highest resolution of data, sub-modules S²⁰, S²¹, S²² belong to the second floor operating on lower resolution data, sub-modules S³⁰, S³¹ belong to the third floor operating on even lower resolution data and sub-module S⁴⁰ operates on the lowest resolution data.

The arrows going from a higher floor to a lower floor (e.g. from S¹⁰ to S²⁰) indicate downsampling of data (e.g. in accordance with downsampling processes described in the above) and the arrows going from a lower floor to a higher floor (e.g. from S²¹ to S¹²) indicate upsampling of data (e.g. interpolation).

The dimensions of the latent variables output by each sub-module of a same floor may be the same. In some implementations, the dimensions of the latent variables input to each sub-module is different from the dimensions of the data outputted by a preceding sub-module of the same floor. This is due to the fact that some sub-modules, such as sub-module S¹¹ or S²¹, receives two sets of latent variables as input data, one set from a preceding sub-module of the same floor and one set (optionally upsampled) from a lower floor. Such sub-modules may first combine the two sets of latent variables, e.g. using concatenation, averaging or selecting the maximum input data element from each version. Alternatively, the at least one neural network layer of the sub-module is configured to accept both versions as input and converge them to a single set of output latent variables.

With further reference to FIG. 5b it is seen that the sub-modules S¹⁰, S¹¹, S¹², S¹³, S²⁰, S²¹, S²², S³⁰, S³¹, S⁴⁰ forms a sequence of initial processor modules 21:1, 21:2, 21:3, 21:4 each comprising at least one sub-module S¹⁰, S¹¹, S¹², S¹³, S²⁰, S²¹, S²², S³⁰, S³¹, S⁴⁰. As seen, the first processor module 21:1 comprises one sub-module S¹⁰ and the second processor module 21:2 takes latent variables from the first processor module 21:1 and downsampled input data In² from the multi-scale input block 25 as input and processes this data with sub-modules S²⁰ and S¹¹. In a similar way, the third processor module 21:3 takes latent variables from the second processor module 21:2 and downsampled input data In³ as input and processes this data with sub-modules S³⁰, S²¹, S¹². Finally, the fourth processor module 21:4 takes latent variables from the third processor module 21:3 and downsampled input data In⁴ as input and processes this data with sub-modules S⁴⁰, S³¹, S²², S¹³.

While FIG. 5a and FIG. 5b shows a nested block with four floors it is understood that this setup is merely exemplary. It is envisaged that the nested block alternatively is realized using only two floors (with three sub-modules) or using three floors (with six sub-modules). Furthermore, the nested block may comprise more than four floors wherein the multi-scale input block 25 is configured to output the same number of different resolutions. In general, a nested block with A floors comprises A (A+1)/2 sub-modules and receives A different resolution as input data.

The final processor module 21:n is an aggregation neural network block comprising one or more aggregation sub-modules A¹, A², . . . . Aⁿ trained to make a prediction of the target data. Each aggregation sub-module A¹, A², . . . . Aⁿ comprises at least one neural network layer. In some implementations the aggregation neural network block comprises a plurality of convolutional layers, pooling layers or recurrent layers. Convolutional layers are used to reduce the channel number C gradually, the pooling layers are to reduce the width W and/or height D dimension, and recurrent layers help to sequence the outputs.

In one embodiment, the aggregation neural network block comprises a plurality of convolutional layers configured to reduce the number of channels to match the number of channels in the target data. The number of convolutional layers depends on the difference between the number of channels output by the initial neural network modules 21:1, 21:2, 21:3, 21:4 and the number of channels of the target data. For example, if the number of channels provided as input to the aggregation neural network block 21:n is Nᵢ and the number of channels of the target data is N₀ the number of convolutional layers N_{C} used in the aggregation neural network block 21:n can be approximated as

$${N}_{C} = [ {log}_{s 1} \frac{{N}_{j}}{{N}_{o}} ] \qquad Eq . 5$$

where s1 denotes the decrease factor of each convolutional layer. For instance, if the number of channels in the target data is two (as would be the case for stereo audio signal output with two channels) and the number of channels of the data being outputted by the initial processor modules 21:1, 21:2, 21:3, 21:4 is 64 there would be approximately log₂(32)=5 convolutional layers if each convolutional layer has a channel decrease factor of s₁=2.

In a similar manner, the number Nₚ of pooling layers can be approximated based on the difference in width W and height H dimension of the data output by the initial processor modules 21:1, 21:2, 21:3, 21:4. If the number of frames in the width W and height H dimension is to be reduced from Fi to Fo wherein Fo is the number of frames in the target data the number of pooling layers is approximately

$${N}_{P} = [ {log}_{s 2} \frac{{F}_{i}}{{F}_{o}} ] \qquad Eq . 6$$

wherein S₂ denotes the pooling size of each pooling layer.

FIGS. 5a and 5b also shows a plurality of supervisor neural network modules 22:1, 22:2, 22:3, 22:4 each being configured to make its own prediction of the target data based on the output latent variables of different initial processor modules 21:1, 21:2, 21:3, 21:4. Each supervisor module 22:1, 22:2, 22:3, 22:4 may be similar in structure to the aggregation neural network block 21:n as the supervisor modules 22:1, 22:2, 22:3, 22:4 perform a similar task, namely construction of a prediction (in the target data dimension) based on latent variables of the first floor resolution. In some embodiments, the architecture of each supervisor 22:1, 22:2, 22:3, 22:4 is identical to the architecture of the aggregation neural network block 21:n although with individual internal weights.

Accordingly, each initial processor module 21:1, 21:2, 21:3, 21:4 adds processing complexity both in terms of consideration of a new, lower resolution and more abstract representation of the features, and in terms of processing the existing resolutions with additional sub-modules which also consider the new lower resolution. This processor setup has proven beneficial when using employing the method of designing a neural network processor. For example, if the second initial processor outputs data associated with a sufficiently low loss it may be determined that initial processor modules 21:1 and 21:2 (sub-modules S¹⁰, S¹¹, S²⁰) together with supervisor module 22:2 and used as a standalone neural network processor.

FIGS. 5a and 5b also depict that the sub-modules S¹⁰, S¹¹, S¹², S¹³, S²⁰, S²¹, S²², S³⁰, S³¹, S⁴⁰ of the nested block may be arranged in a dense structure wherein the sub-modules of each floor are provided with skip connections. As seen, the output data of each sub-module of a floor is provided not only to the directly subsequent sub-module of the same floor, but also to each further subsequent sub-module. For example, in the first floor of the four-floor nested block 26, the output of sub-module S¹⁰ is provided to both S¹² and S¹³ in addition to being provided to the directly subsequent sub-module S¹¹.

FIG. 5c depicts another example of how the supervisor modules 22:1, 22:2, 22:3, 22:4 could be arranged to supervise the latent variables of the initial processor modules. In this embodiment, sub-modules S¹⁰, S²⁰, S³⁰, S⁴⁰ forms a first alternative processor module whereby the output of S⁴⁰ is provided to a supervisor module 22:4 which makes a prediction of the target data. The second alternative processor module comprises sub-modules S¹⁰, S²⁰, S³⁰, S⁴⁰, as well as S³¹ and supervisor module 22:3 performs the prediction associated with the second alternative processor module. This pattern is repeated for the third and fourth alternative processing modules which add sub-modules S²¹, S²² and S¹¹, S¹², S¹³ respectively.

A difference between the supervisor module placement in the embodiment of FIG. 5c compared to the embodiment of FIG. 5a and FIG. 5b is that the supervisors of FIG. 5c operate on latent variables of different resolution (of different floors). While both embodiments are effective at obtaining different loss measures which could be used for training and adjusting the processor modules the placement of the supervisor modules according to FIG. 5a and FIG. 5b enables a large spectra of easily separable neural networks to be trained simultaneously, wherein the neural networks range from very simple architectures operating on a single resolution of input data to large neural networks operating on two, three, four or more resolutions of input data.

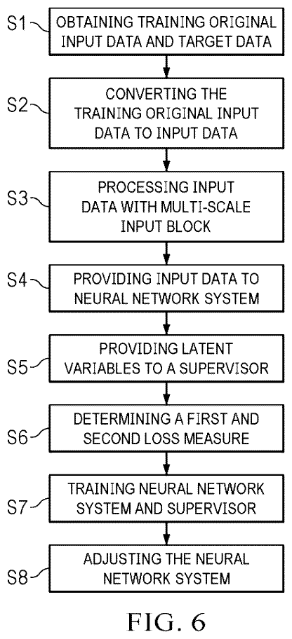

With reference to FIG. 5b and FIG. 6 a method for designing a neural network processor will now be described. At step S1 training original input data and associated ground truth target data is obtained. The training original input data may be distorted version of the ground truth training data and/or the ground truth training data is an enhanced version of the training original input data. At step S2 the training original input data is provided to a feature extractor 10 which extracts feature domain latent variables using a plurality of consecutive feature extractor modules. The feature domain latent variables are used as input data to the processor 20. At step S3 the input data is provided to a multi-scale input block 25 which performs at least one downsampling operation on the input data to generate at least two resolutions of input data. Both resolutions of input data are provided to the initial processor modules 21:1, 21:2, 21:3, 21:4 at step S4. The initial processor modules 21:1, 21:2, 21:3, 21:4 processes the data and provides the processed data to a final processor module 21:n wherein the final processor module 21:n outputs a first prediction of target data.

At step S5, the latent variables of at least one processor module 21:1, 21:2, 21:3, 21:4 is provided to an associated supervisor module 22:1, 22:2, 22:3, 22:4 which comprises a plurality of learnable nodes for generating a second prediction of the target data. At step S6 the first and second prediction of the target data is provided to a loss calculator which determines a first and second loss associated with each respective prediction of the target data by comparing the prediction of the target data to the ground truth data.

At step S7 the trainable nodes of the processor 20 and the at least one supervisor module 22:1, 22:2, 22:3, 22:4 are updated based on the first and second loss so as to reduce at least one of the first and second loss. At step S8 the method involves adjusting the neural network processor by adding, removing or replacing a neural network sub-module or processor module based on the first and second loss.

In some implementations, steps S1, S2 and S3 are omitted. For instance, the feature domain latent variables may already be available as input data meaning that it is not necessary to process the training data with a feature extractor 10. Additionally, while initial processing modules operating on multiple resolutions achieve good performance it is envisaged that initial processor modules operating on a single resolution (e.g. sub-modules of a single floor) are used instead, meaning that the multi-scale input block 25 is not needed in all implementations.

There are many types of neural network layer(s) that could be successfully used in each sub-module S^{mn} discussed in the above. In the following, a few examples of sub-module types will be described although it is understood that these are merely examples, and that many other types are possible.

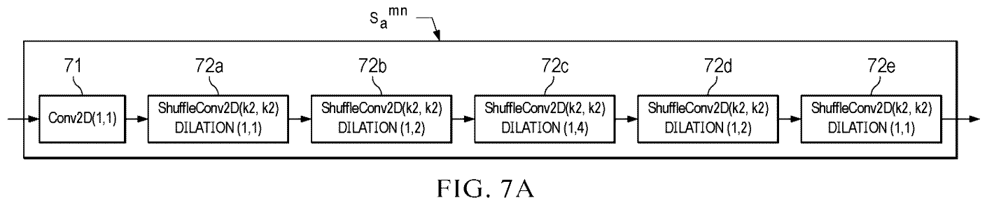

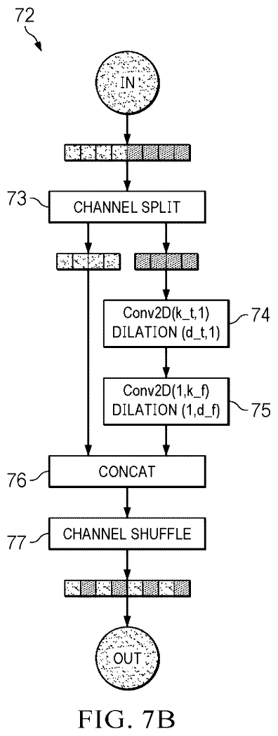

FIG. 7a is a block-chart illustrating a first type of sub-module Sam “. The first type of sub-module Sam” may be referred to as a shuffle convolutional neural network block. As seen, the input data of the shuffle convolutional neural network block (e.g. originating from the feature extractor, multi-scale input block or a preceding sub-module) is provided to a two-dimensional 1*1 convolutional layer 71. The output of the two-dimensional 1*1 convolutional layer 71 is provided to a series of subsequent two-dimensional shuffling convolutional layers 72a, 72b, 72c, 72d, 72e. Each two-dimensional shuffling convolutional layer has a filter size of k₂*k₂. Furthermore, the dilation of the second two-dimensional shuffling convolutional layer 72b in the series of subsequent two-dimensional shuffling convolutional layers is increased in comparison to the first two-dimensional shuffling convolutional layer 72a. For instance, the dilation increases from one (in height H and/or width W) to two. Similarly, the dilation of the third two-dimensional shuffling convolutional layer 72c in the series of subsequent two-dimensional shuffling convolutional layers is increased in comparison to the second two-dimensional shuffling convolutional layer 72b. For instance, the dilation increases from two (in height H and/or width W) to four.

The remaining two-dimensional shuffling convolutional layers 72d, 72e in the series of subsequent two-dimensional shuffling convolutional layers then decreases the dilation in an analogous manner to achieve a final dilation sequence of 1, 2, 4, 2, 1.

With further reference to FIG. 7b there is depicted a two-dimensional shuffling convolutional layer 72 used in the shuffle convolutional neural network block Sₐ^{mn} according to some implementations. The shuffling convolutional layer 72 comprises a channel splitting block 73 which splits the channels of the data input to the shuffling convolutional layer 72 into at least two groups, a first group and a second group. For instance, if the number of channels C is an even number the splitting block 73 may split the channels into two groups with half of the channels in each group. However, it is also envisaged that there are different numbers of channels in each group.

The second group of channels are provided to two two-dimensional convolutional neural network layers 74, 75. The first two-dimensional convolutional layer 74 has a filter size of kₜ, wherein kₜ is at least two and indicates the filter size in the width, W, dimension. The first two-dimensional convolutional layer 74 has a size of one in the height, H, direction and optionally a dilation factor dt. For example, di is equal to one, two or four depending on where in the shuffle convolutional neural network block Sₐ^{mn} the layer is used.

The output of the first two-dimensional convolutional layer 74 is provided to a second two-dimensional convolutional layer 75. The second two-dimensional convolutional layer 75 has a filter size of k_{f}, wherein k_{f} is at least two and indicates the filter size in the height, H, dimension. The second two-dimensional convolutional layer 75 has a size of 1 in the height, W, direction and optionally a dilation factor dr. For example de is equal to one, two or four depending on where in the shuffle convolutional neural network block Sₐ^{mn} the layer is used.

It is envisaged that the order of the two-dimensional convolutional layers 74, 75 can be in the reversed or, and/or that the two-dimensional convolutional layers 74, 75 can be replaced with a single two-dimensional convolutional layer, e.g. with a filter size being at least two in both the height H and width W dimension.

Accordingly, the output of the second two-dimensional convolutional layer 75 has the same number of channels as that of the data inputted to the first two-dimensional convolutional layer 74 and the output of the second two-dimensional convolutional layer 75 is concatenated with the first group of channels with a concatenation block 76. The result of the concatenation is data of the same dimensions as that which was input to the shuffling convolutional layer 72 wherein some of the channels have been processed and some are left unprocessed.

The concatenated channels are provided to a shuffle block 77 which shuffles the order of the channels to produce the final output of the shuffling convolutional layer 72. The shuffling performed by the shuffle block may be predetermined (e.g. placing the channels such that every second channel is of the first group and every other channel is from the second group) or randomized. While the shuffling as such could be arbitrary, the selected shuffling should be retained so as to be performed in the same way each training iteration and/or inference iteration.

Alternatively, the shuffling convolutional layer 72 involves splitting channels into three or more groups, wherein at least one group is left unprocessed, one group is processed with the first and second two-dimensional convolutional layers 74, 275 and one group is processed with a third and fourth two-dimensional convolutional layer (not shown) in a manner analogous to the processing with the first and second two-dimensional convolutional layer 74, 75. In one implementation, the channels are split into three groups, wherein one group is left unprocessed, one group is processed with filters extending in the width W dimension and one group is processed with filters extending in the height H dimension.

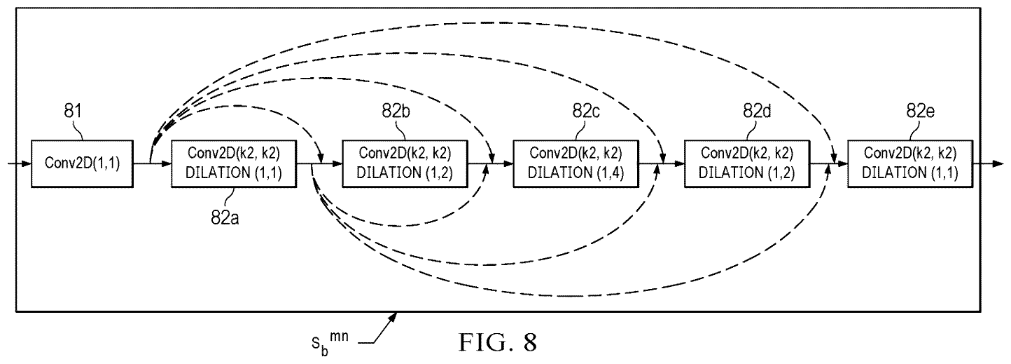

FIG. 8 is a block-chart illustrating a second type of sub-module S_{b}^{mn}. The input data (e.g. originating from the feature extractor, multi-scale input block or a preceding sub-module) is provided to a two-dimensional 1*1 convolutional layer 81. The output of the two-dimensional 1*1 convolutional layer 81 is then provided to a series of two-dimensional convolutional layers 82a, 82b, 82c, 82d, 82e wherein each layer has the same filter size k₂*k₂. In some implementations, the dilation factor increases from the first to second layer, and from the second to third layer before the dilation decreases from the third to fourth layer and from the fourth to fifth layer. Again the dilation sequence of the two-dimensional convolutional layers 82a, 82b, 82c, 82d, 82e may be 1, 2, 4, 2, 1 in at least one of width W and height H dimension of the data.

While sub-module Sₐ^{mn} from FIG. 7a and FIG. 7b used shuffle convolutional layers the sub-module S_{b}^{mn} may use conventional two-dimensional convolutional layers. On the other hand, sub-module S_{b}^{mn} uses a dense architecture wherein the input data of each layer is based on the output of each preceding layer via skip connections (i.e. not only the directly preceding layer).

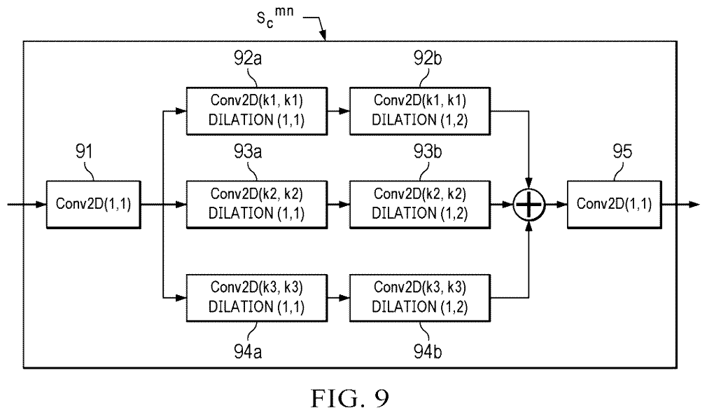

FIG. 9 is a block-chart illustrating a third type of sub-module S_{c}^{mn} referred to as a multi-scale sub-module. As seen, the input data of the multi-scale sub-module S_{c}^{mn} (e.g. originating from the feature extractor, multi-scale input block or a preceding sub-module) is provided to a two-dimensional 1*1 convolutional layer 91. The output of the 1*1 two-dimensional convolutional layer is then provided to three parallel processing branches, wherein each branch comprises two two-dimensional convolutional layers 92a, 92b, 93a, 93b, 94a, 94b. The convolutional layers 92a, 92b, 93a, 93b, 94a, 94b of the different branches have different filter sizes. For instance, the filter size of the convolutional layers 92a, 92b in the first processing branch has a smaller filter size of k1*k1 compared to the convolutional layers in the second and third processing branch and the filter size of the convolutional layers 93a, 93b in the first processing branch has a filter size of k2*k2 that is smaller compared to filter size k3*k3 in the convolutional layers 94a, 94b of the third processing branch, i.e. k1<k2<k3.

Accordingly, the convolutional layers of the different branches will be trained to perform processing on different levels of granularity, with the third procession branch using large filters suitable for capturing low-frequency dependencies in the latent variables whereas the first processing branch is more suitable for capturing high-frequency dependencies in the latent variables.

The output of each processing branch is fed to a summation point which combines the output of each processing branch and then provides the combined output data to a final 1*1 two-dimensional convolutional layer 95 which makes the final prediction and generates the output of the sub-module S_{c}^{mn}.

In some implementations, each processing branch employs an increasing dilation factor. That is, at least one two-dimensional convolutional layer of each processing branch has a dilation factor which is higher compared to a preceding two-dimensional convolutional layer in the same processing branch. As exemplified in FIG. 9, the second convolutional layer 92b, 93b, 94b in each processing branch has a dilation factor of two in either the height H or width W dimension whereas the first convolutional layer 92a, 93a, 94a in each processing branch has a dilation factor of one.

It is understood that the multi-scale sub-module S_{c}^{mn} can also be realized with only two processing branches, or more than three processing branches. Additionally or alternatively, each processing branch may comprise more than two two-dimensional convolutional layers 92a, 92b, 93a, 93b, 94a, 94b.

While the three types of sub-modules Sₐ^{mn}, S_{b}^{mn}, S_{c}^{mn} shown in FIG. 7, FIG. 8 and FIG. 9 are merely exemplary and many other types are also possible to use it is noted that three sub-modules Sₐ^{mn}, S_{b}^{mn}, S_{c}^{mn} all employ different methods for avoiding losing processing results from earlier modules which e.g. helps to solve the vanishing gradient problem for deep models, which facilitates training. For instance, the skip-connections of the second type of sub-module S_{b}^{mn} means that it is easier to train all layers during back-propagation, even those layers which occur early in the chain, as unprocessed features are fed forward in the chain of modules. Similarly, the multi-scale hierarchy of the third type of sub-module S_{c}^{mn} and/or the multi-scale hierarchy of the nested block from FIGS. 5a, 5b and 5c also shortens the distance between the early layers in the chain and the later layers in the chain. Furthermore, the first type of sub-module Sₐ^{mn} reduces the vanishing gradient problem by passing unprocessed channels forward from each layer in the chain of layers which lowers the average number of layers between a determined loss measure and an internal trainable variable. An additional benefit of the shuffling convolutional layer is that the vanishing gradient problem is resolved without skip connections, which makes the resulting processor less complex.

Unless specifically stated otherwise, as apparent from the following discussions, it is appreciated that throughout the disclosure discussions utilizing terms such as “processing”, “computing”, “calculating”, “determining”. “analyzing” or the like, refer to the action and/or processes of a computer hardware or computing system, or similar electronic computing devices, that manipulate and/or transform data represented as physical, such as electronic, quantities into other data similarly represented as physical quantities.

It should be appreciated that in the above description of exemplary embodiments of the invention, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention. Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with instructions for carrying out such a method or element of a method forms a means for carrying out the method or element of a method. Note that when the method includes several elements, e.g., several steps, no ordering of such elements is implied, unless specifically stated. Furthermore, an element described herein of an apparatus embodiment is an example of a means for carrying out the function performed by the element for the purpose of carrying out the embodiments of the invention. In the description provided herein, numerous specific details are set forth. However, it is understood that embodiments of the invention may be practiced without these specific details. In other instances, well-known methods, structures and techniques have not been shown in detail in order not to obscure an understanding of this description.

The person skilled in the art realizes that the present invention by no means is limited to the embodiments described above. On the contrary, many modifications and variations are possible within the scope of the appended claims. For example, while FIG. 5a, 5b, 5c shows a nested block with four floors it is envisaged that fewer or more than four floors can be used. Additionally, the same type of sub-module modules Sₐ^{mn}, S_{b}^{mn}, S_{c}^{mn} may be used for each sub-module in the nested block 26. For example, if each sub-module is a shuffle convolutional layer the nested block may be referred to as a shuffle nested block. Alternatively, different types of sub-modules may be used in the nested block at the same time.

1. A method for designing a neural network processor, the method comprising:
obtaining input data and corresponding ground truth target data;
providing the input data to the neural network processor comprising a plurality of trainable nodes for outputting a first prediction of target data given the input data;
the neural network processor comprising a consecutive series of initial processing modules, each initial processing module comprising a plurality of trainable nodes for outputting latent variables that are used as input data to a subsequent initial processing module in the series, and a final processing module comprising a plurality of trainable nodes for outputting the first prediction of target data given latent variables from a final initial processing module,
providing the latent variables output by at least one initial processor module to a supervisor module, the supervisor module comprising a plurality of trainable nodes for outputting a second prediction of target data based on latent variables;
determining a first loss measure and a second loss measure by comparing the first prediction of target data with the ground truth target data and comparing the second prediction of the target data with the ground truth target data, respectively;
training trainable nodes of the neural network processor and the supervisor module based on the first loss measure and second loss measure; and
adjusting the neural network processor based on the first loss measure and the second loss measure, wherein adjusting the neural network comprises at least one of removing an initial processor module, replacing a processor module and adding a processor module.

2. The method according to claim 1, further comprising:
obtaining training original input data; and
converting the training original input data to input data by providing the training original input data to a neural network feature extractor, the feature extractor being trained to convert the training original input data to feature domain input data.

3. The method according to claim 2, wherein feature domain input data has a higher number of dimensions compared to the training original input data.

4. The method according to claim 1, further comprising:
providing the input data to a multi-scale input block, the multi-scale input block being configured to downsample in the input data to generate downsampled input data of a reduced resolution;
providing the downsampled input data to a specific initial processor module of the series of initial processor modules;
wherein the specific initial processor module comprises a plurality of trainable nodes for outputting a specific set of latent variables based on the latent variables of a preceding initial processor module and the downsampled input data.

5. The method according to claim 4, wherein said specific initial processor module comprises a first sub-module and a second sub-module, wherein each sub-module comprises at least one neural network layer, the method further comprising:
providing the downsampled input data to the second sub-module;
predicting, with the second sub-module, an intermediate set of latent variables based on the downsampled input data; and
predicting, with the first sub-module, the specific set of latent variables based on the set of latent variables from the preceding initial processor module and the intermediate set of latent variables.

6. The method according to claim 5, further comprising upsampling the intermediate set of latent variables prior to providing the intermediate set of latent variables to the first sub-module.

7. The method according to claim 5, further comprising:
downsampling the set of latent variables from the preceding initial processor module to the downsampled resolution; and
providing the downsampled set of latent variables from the preceding initial processor module to the second sub-module, wherein the second sub-module comprises trainable nodes for predicting the intermediate set of latent variables based on the downsampled input data and the downsampled set of latent variables from the preceding processor module.

8. The method according to claim 1, wherein at least one initial processor module or sub-module comprises at least one shuffle convolutional layer configured to receive ingestion data and output processed data, the method further comprising.
splitting the channels of the ingestion data into a first channel group and a second channel group;
processing the second channel group with at least one neural network layer, to obtain a processed second channel group; and
shuffling the order of the first channel group with the processed second channel group to generate the processed data.

9. The method according to claim 1, wherein at least one initial processor module or sub-module comprises a dense neural network block or a multi-scale neural network block.

10. The method according to claim 4, wherein downsampling comprises processing the input data with a convolutional layer with a stride of at least two.

11. The method according to claim 4, wherein downsampling comprises max pooling or average pooling, wherein
max pooling comprises determining a maximum data value in a pooling region of the input data; and
average pooling comprises determining an average data value in a pooling region of the input data, wherein the pooling region comprises at least two data elements of the input data.

12. The method according to claim 1, wherein each initial processor module or sub-module comprises at least one of a convolutional layer and a recurrent layer.

13. A method for designing multiple neural network processors comprising the steps of claim 1, and:
forming a low complexity neural network processor comprising all initial processor modules preceding the supervisor module and the supervisor module; and
forming a high complexity neural network processor comprising all initial processor modules and the final neural network module.

14. A computer-implemented neural network comprising:
a nested block, the nested block comprising:
at least a first floor and a second floor, wherein the first floor comprises a number n−1 of consecutive neural network sub-modules operating on high resolution input data and the second floor comprises a number n−2 of consecutive neural network sub-modules operating on low resolution input data, and
a first sub-module of the first floor is trained to predict high resolution latent variables based on high resolution input data,
a first sub-module of the second floor is trained to predict low resolution latent variables based on low resolution input data and high resolution latent variables from the first sub-module of the first floor, and
a second sub-module of the first floor is configured to predict high resolution second latent variables based on the high resolution latent variables and low resolution latent variables.

15. The computer-implemented neural network according to claim 14, wherein the first sub-module of the second floor is trained to predict low resolution latent variables based on downsampled high resolution latent variables from the first sub-module of the first floor, and the second sub-module of the first floor is configured to predict high resolution second latent variables based on upsampled low resolution latent variables.

16. The computer-implemented neural network according to claim 14, further comprising:
a multi-scale input block configured to obtain high resolution input data and downsample the high resolution input data to obtain low resolution input data and provide the low and high resolution input data to the nested block.

17. The computer-implemented neural network according to claim 14, further comprising:
an aggregation neural network block comprising at least one neural network layer with a plurality of trainable nodes for predicting output data based on the high resolution second latent variables of the first floor.

18. The computer-implemented neural network according to claim 17, wherein the high resolution second latent variables are represented with a first number of channels and the output data is represented with a second number of channels, and wherein the first number of channels is greater than the second number of channels.

19. The computer-implemented neural network according to claim 14, wherein at least one sub-module comprises a shuffling convolutional layer, configured to process only a true subset of the channels in data input to the shuffling convolutional layer and shuffle the order of the channels.

20. The computer-implemented neural network according to claim 19, wherein the shuffling convolutional layer comprises:
at least one channel splitter, configured to split the channels of divide the channels of data input to the shuffling convolutional layer into at least a first group and a second groups, wherein each group comprises at least one channel,
at least one two-dimensional convolutional layer configured to process the second group of channels to output processed second group channels; and
a shuffling block, configured to shuffle the order of the first group of channels and the processed second group channels,
wherein the first group of channels shuffled with the processed second group of channels is the output of the shuffling convolutional layer.

21. A computer program product comprising instructions which, when the program is executed by a computer, causes the computer to carry out the method according to claim 1.

22. A computer-readable storage medium storing the computer program according to claim 21.
